(19) United States
(12) Patent Application Publication
(10) Pub. No.: US 2026/0222006 A1
(43) Pub. Date: Jul. 30, 2026

(54) SYSTEM AND METHOD FOR RESTORING OFFSHORE PLATFORM COMMUNICATION

(71) Applicant: SAUDI ARABIAN OIL COMPANY, Dhahran (SA)

(72) Inventors: Akram K. RAGABAN, Dhahran (SA); Zaur ALSANOV, Dhahran (SA)

(73) Assignee: SAUDI ARABIAN OIL COMPANY, Dhahran (SA)

(21) Appl. No.: 19/038,897

(22) Filed: Jan. 28, 2025

(51) Int. Cl. H04B 3/46; H04B 3/54

(52) U.S. Cl. CPC H04B 3/46; H04B 3/54; H04B 2203/5429

(57) ABSTRACT

A method for restoring communication to an aging remote facility having a wellhead platform (WHP) coupled to a tie-in platform (TP) by way of a composite copper cable includes determining the existence of electrical continuity between the WHP and TP on at least two cores of the composite copper cable, and establishing digital subscriber line (DSL) communication between the WHP and TP using the at least two cores of the composite copper cable, said establishing comprising communicating data at a first data rate, and changing the first data rate until an optimal data rate is achieved.

### FIELD OF THE DISCLOSURE

The present disclosure relates to restoration of communications with aging facilities such as offshore platforms.

### BACKGROUND OF THE DISCLOSURE

Offshore hydrocarbon operations frequently suffer from rough weather throughout the year. Rough weather means that aviation and marine services are unable to dispatch helicopters and boats to the platform. As a result, operating facilities will be blind of the offshore platforms and field operators cannot visit the platforms to check readings, equipment healthiness, platform status and ensure platforms are operating within normal parameters and avoid emergency situations.

In addition to safety, significant cost savings can be achieved in a one-year calendar by reducing the number of trips to the platform for non-emergency tasks checking readings, and equipment healthiness, including dispatching helicopters, boats, and sending field operators, maintenance technicians, and engineers to the field.

Unfortunately, physical visits to the platforms may become necessary because aged offshore facilities are suffering from either poor or unstable network communication, making remote data access impossible. Thus often the SCADA operators console's view of the fields is cut off, even though real-time and reliable data are crucial for all operating facilities in the oil and gas industry.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof.

Rather, the primary purpose of this summary is to present some concepts of the disclosure in a simplified form prior to the more detailed description that is presented hereinafter.

According to an embodiment consistent with the present disclosure, a method for restoring communication to an aging remote facility having a wellhead platform (WHP) coupled to a tie-in platform (TP) by way of a composite copper cable includes determining the existence of electrical continuity between the WHP and TP on at least two cores of the composite copper cable, and establishing digital subscriber line (DSL) communication between the WHP and TP using the at least two cores of the composite copper cable, said establishing comprising communicating data at a first data rate, and changing the first data rate until an optimal data rate is achieved.

In another embodiment, a communication system includes a first DSL switch at a wellhead platform (WHP), an RTU (remote terminal unit) at the WHP, a second DSL switch at a tie-in platform (TP), and a composite copper cable having at least two cores establishing electrical communication between the first and second DSL switches for exchange of RTU data between the WHP and TP.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a flow diagram in accordance with one embodiment.

FIG. 2 is a block diagram of an implementation of a design package in accordance with certain embodiments.

FIG. 3 is a block diagram of an implementation showing the use of two ports in accordance with certain embodiments.

FIG. 4 is a block diagram of an implementation showing the use of a split-channel topology in accordance with certain embodiments.

FIG. 5 is a schematic diagram showing use of Industrial Ethernet extenders allowing connection to Ethernet networks over long distances and multiple nodes.

### DETAILED DESCRIPTION

Embodiments of the present disclosure will now be described in detail with reference to the accompanying drawing figures. Like elements in the various figures may be denoted by like reference numerals. Further, in the following detailed description, specific details are set forth in order to provide a more thorough understanding of the claimed subject matter.

However, it will be apparent to one of ordinary skill in the art that the embodiments disclosed herein may be practiced without these specific details, or with details that are not described herein in the interest of clarity. Thus in some instances, well-known features have not been described in detail to avoid unnecessarily complicating the description. Additionally, it will be apparent to one of ordinary skill in the art that the scale of the elements presented in the accompanying drawing figures may vary without departing from the scope of the present disclosure.

Embodiments in accordance with the present disclosure generally relate to restoration of communications with aging facilities such as offshore platforms.

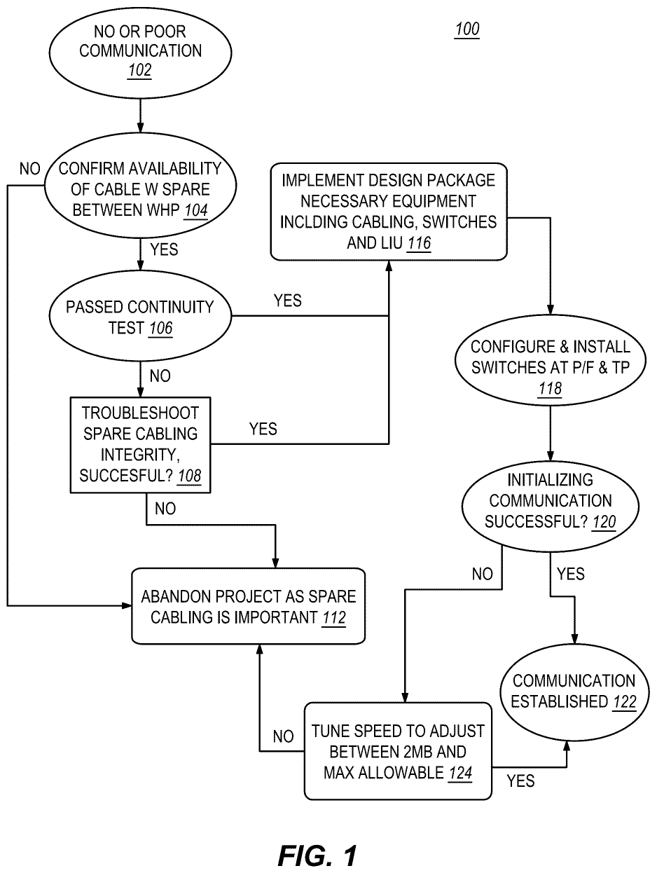

FIG. 1 is a flow diagram of a method 100 for restoring network communications to a remote facility such as an offshore oil platform in accordance with certain embodiments. The method begins at 102 by identifying an aging well head platform (WHP) having no or poor communication with a tie-in (TP) platform. At 104, it is confirmed whether sufficient quality spare subsea conductor/wire or the like is available between the two locations, and at 106, continuity of such spare cable is ascertained and a determination of its integrity is made at 108. If these conditions are met, then at 116 a design package in accordance with certain embodiments is implemented; whereas if they are not, then a troubleshooting of the spare cabling integrity is commenced at 108. If the troubleshooting is successful, then at 116 the design package in accordance with certain embodiments is implemented. Otherwise, the project is abandoned at 112.

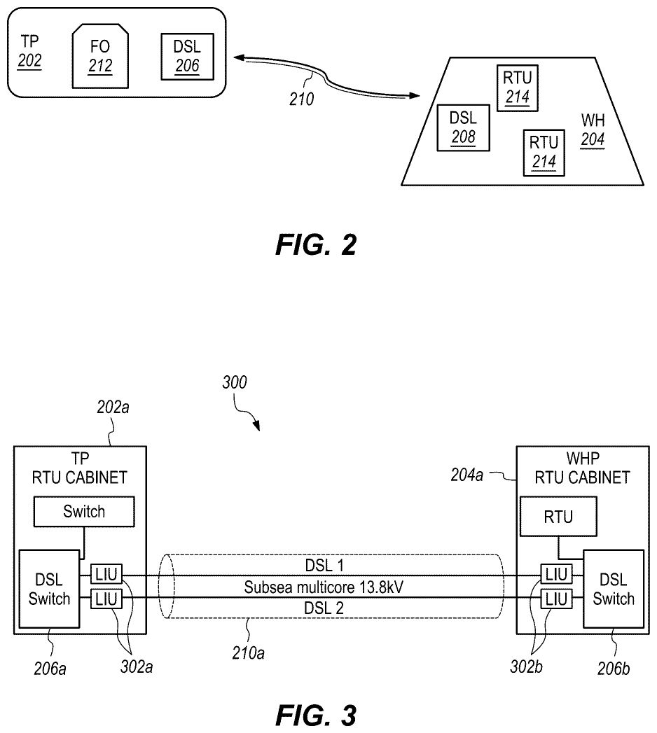

Implementation of the design package, at step 118, involves configuration and installation of DSL switches at the two locations. With reference to FIG. 2, these two locations are shown as the tie-in platform 202 and at the wellhead platform 204. In certain embodiments, the switches are DSL (digital subscriber line) switches 206, 208 and can be installed to replace or supplement existing equipment such as FDM (frequency division multiplexing) modem communication links (not shown) at the respective locations. The DSL communication switches 206, 208 can utilize existing spare cores 210 within composite copper cables interconnecting the tie-in platform 202 and wellhead platform 204 for power distribution and telecommunication to establish DSL communication and connect the wellhead platform to the FO (fiber optic) ring network 212 at the TP platform. This solution provides fast and reliable data transfer for example between a central building of the TP platform 202 that holds the SCADA system (not shown) and offshore RTUs (remote terminal units) 214 exchanging data therewith. This arrangement can also be utilized for any other facilities provided that a pair of good quality cable is available between facilities. Thus returning to FIG. 1, at 120 it is determined that communication initialization is successful using the DSL switches. If so, communication is established at 122. Otherwise, a speed tunning step 124 may be necessary, in which a data transmission rate may decreased (or increased) from a starting point until an optimum communication is established. In certain embodiments, data rate speeds of about 2 Mbits to about 6 Mbits per second are contemplated.

There are multiple topology possibilities with DSL communication devices that can be deployed in accordance with the teachings hereof. FIG. 3 illustrates a point-to-point (one-to-one) arrangement 300 in accordance with certain embodiments. Point-to-point topology assumes TP 202a and WHP 204a respectively have DSL communication devices 206a, 206b connected to each other on line 210 a either with 1 or 2 ports connected through appropriate LIUs (line isolation units) 302a, 302b directly as shown. The LIUs may for example may have 20 KV rating in accordance with certain embodiments. In some embodiments (not shown), due to spare cores availability limitations, a single channel communication arrangement can be selected (only PORT 1 or PORT 2 is utilized for DSL communication for example, rather than both PORT 1 and PORT 2). The use of two ports as shown in FIG. 3 increases DSL speed as both ports can be used to double up the connection speed. Most offshore communication links configured in this manner are able to for example establish from about 2 Mbit to about 6 Mbit data transfer rates, which are adequate for RTU applications.

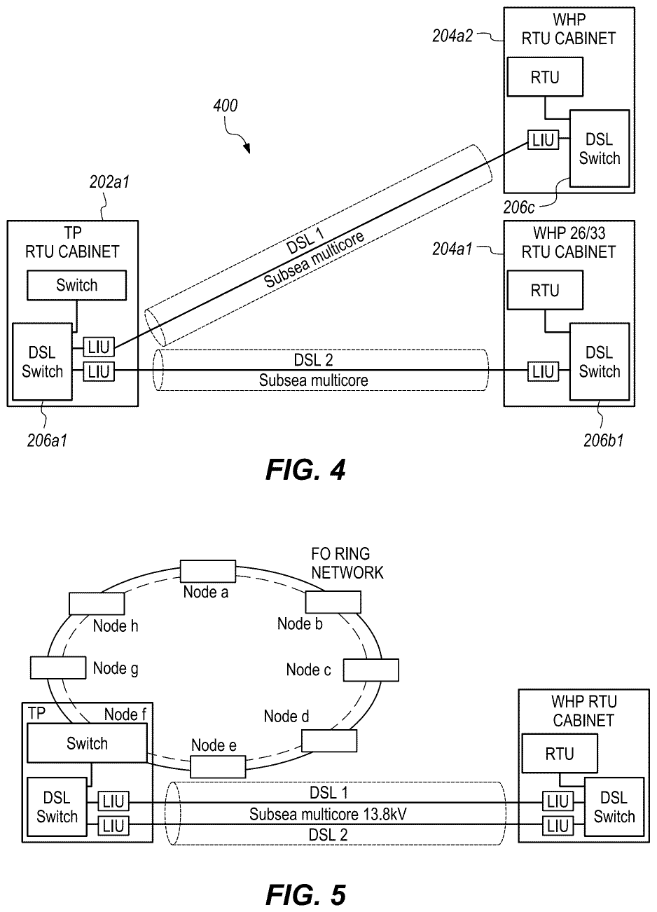

FIG. 4 illustrates an arrangement 400 exhibiting a split channel topology in accordance with certain embodiments. In such a configuration, 2 DSL extender devices 206a1, 206b1 respectively on TP 202a1 and WHP 204a1 may be connected to a 3^{rd} DSL device 206c on WHP 204a2 directly by splitting DSL ports between 2 platforms. Thus in the shown split channel arrangement, communication is established on PORT 1 to DSL device 206b1 on one platform and PORT 2 connected to DSL device 206c on another platform.

It will be appreciated that in both configurations (point-to-point 300 or split channel 400) the DSL device located on the tie-in platform may be configured to act as a main gateway device communicating with a slave device on the WHP platform. At the WHP side, the RTU is connected to the DSL extender switch; whereas at the TP side, the DSL switch is connected to the fiber optic ring network via a network switch.

A representative integration diagram is provided in FIG. 5. Industrial Ethernet extenders allow cost-effective Ethernet networks to be created over long distances, at high data rates, and can be used to couple the fiber optic ring to the DSL switches. The DSL/SHDSL technology allows the use of many types of existing cabling capacity which provides substantial financial, material and time savings. With support for transparent point-to-point connections, multidrop networks, redundant rings, legacy serial connections and layer 3 routing functions, the DSL extenders (see also 206, 208 (FIG. 2); 206a, 206b (FIG. 3); 206a1, 206b1, 206 (FIG. 4)) can provide fast, reliable and easy to configure networks to boost communication capabilities.

In certain embodiments, the line isolation units (302, FIG. 3 e.g.) may have a rating about 20 KV. The electrical isolation is important for safety reasons in order to protect users and devices (RTUs, switches, modems, SCADA, smart meters, etc.) from over-voltages. Such voltages are caused e.g. by lightning strikes or electromagnetic induction in power lines parallel to telecommunication cables causing electromagnetically induced voltage. In addition, LIUs reduce near-end crosstalk, provides echo compensation, for separating the sending and reception directions and provide impedance matching. Lines and transmitters can have different resistances, which can lead to power losses without adaptation. Adaptation plays an important role in the telecommunications sector as low energy is transmitted.

In certain embodiments, existing currently-installed 20 KV LIUs can be used for the DSL communication in accordance with certain embodiments. However, purpose-installed LIUs of same or different ratings at the TP and/or WHP sides can also be used in accordance with certain embodiments. This can be after the electrical cable is spliced to protect communication devices and personnel on both ends. In certain embodiments, if no electrical cable is run in parallel with the communication cable the LIU units may not be mandatory and may thus be dispensed with in certain embodiments. However, the design needs to be planned and the requirements be analyzed for other electrical surge conditions such as static electricity and/or lightning when making the determination to use LIUs in accordance with certain embodiments.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

The present disclosure is also directed to the following exemplary embodiments, which can be practiced in any combination thereof:
A. A method for restoring communication to an aging remote facility having a wellhead platform (WHP) coupled to a tie-in platform (TP) by way of a composite copper cable, the method comprising:
determining the existence of electrical continuity between the WHP and TP on at least two cores of the composite copper cable; and
establishing digital subscriber line (DSL) communication between the WHP and TP using the at least two cores of the composite copper cable, said establishing comprising communicating data at a first data rate, and changing the first data rate until an optimal data rate is achieved.
B. A communication system comprising:
a first DSL switch at a wellhead platform (WHP);
an RTU (remote terminal unit) at the WHP;
a second DSL switch at a tie-in platform (TP); and
a composite copper cable having at least two cores establishing electrical communication between the first and second DSL switches for exchange of RTU data between the WHP and TP.

Each of embodiments A through B may have one or more of the following additional elements in any combination: Element 1: changing the first data rate comprises increasing the first data rate. Element 2: changing the first data rate comprises decreasing the first data rate. Element 3: the optimal data rate is between about 2 Mbits to about 6 Mbits per second. Element 4: establishing DSL communication comprises connecting to a fiber optic ring at the TP. Element 5: establishing DSL communication comprises connecting to a SCADA system. Element 6: establishing DSL communication comprises using a line isolation unit. Element 7: the line isolation unit is rated at 20 KV. Element 8: establishing DSL communication comprises exchanging RTU (remote terminal unit) data between the WHP and TP.

By way of non-limiting example, exemplary combinations applicable to A through B include: Element 1 with Element 3; Element 2 with Element 3; Element 3 with Element 4; Element 2 with Element 5; Element 1 with Element 6; Element 7 with Element 8;

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The term “based on” means “based at least in part on.” The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 5-10% of the indicated number.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encom passes that apparatus, system, or component, whether or not it or that particular function is activated, turned on, or unlocked, as long as that apparatus, system, or component is so adapted, arranged, capable, configured, enabled, operable, or operative.

What is claimed is:

1. A method for restoring communication to an aging remote facility having a wellhead platform (WHP) coupled to a tie-in platform (TP) by way of a composite copper cable, the method comprising:
determining the existence of electrical continuity between the WHP and TP on at least two cores of the composite copper cable; and
establishing digital subscriber line (DSL) communication between the WHP and TP using the at least two cores of the composite copper cable, said establishing comprising communicating data at a first data rate, and changing the first data rate until an optimal data rate is achieved.

2. The method of claim 1, wherein changing the first data rate comprises increasing the first data rate.

3. The method of claim 1, wherein changing the first data rate comprises decreasing the first data rate.

4. The method of claim 1, wherein the optimal data rate is between about 2 Mbits to about 6 Mbits per second.

5. The method of claim 1, wherein establishing DSL communication comprises connecting to a fiber optic ring at the TP.

6. The method of claim 1, wherein establishing DSL communication comprises connecting to a SCADA system.

7. The method of claim 1, wherein establishing DSL communication comprises using a line isolation unit.

8. The method of claim 7, wherein the line isolation unit is rated at 20 KV.

9. The method of claim 1, wherein establishing DSL communication comprises exchanging RTU (remote terminal unit) data between the WHP and TP.

10. A communication system comprising:
a first DSL switch at a wellhead platform (WHP);
an RTU (remote terminal unit) at the WHP;
a second DSL switch at a tie-in platform (TP); and
a composite copper cable having at least two cores establishing electrical communication between the first and second DSL switches for exchange of RTU data between the WHP and TP.

11. The system of claim 10, further comprising first and second line isolation units coupled to the first and second DSL switches.

12. The system of claim 10, further comprising a fiber optic ring coupled to the second DSL switch.

13. The system of claim 10, wherein the electrical communication is at a nominal about 2 Mbits to 6 Mbits per second.

14. The system of claim 10, further comprising a SCADA system coupled to the second DSL switch.

15. The system of claim 12, further comprising an ethernet switch interfacing the fiber optic ring to the second DSL switch.
